(19) United States
(12) Patent Application Publication
(10) Pub. No.: US 2006/0134545 A1
(43) Pub. Date: Jun. 22, 2006

(54) Negative resist composition and process for formation of resist patterns

(76) Inventors: Jyun Iwashita, Kanagawa (JP); Toshikazu Tachikawa, Kanagawa (JP)

Correspondence Address: WENDEROTH, LIND & PONACK, L.L.P., 2033 K STREET N. W., SUITE 800, WASHINGTON, DC, 20006-1021, US

(21) Appl. No.: 10/549,849

(22) PCT Filed: Mar. 24, 2004
(86) PCT No.: PCT/JP04/04080

§ 371 Date: Dec. 12, 2005

(30) Foreign Application Priority Data
Mar. 28, 2003 (JP) 2003-092767
Feb. 26, 2004 (JP) 2004-051608

(51) Int. Cl. G03C 1/76

(52) U.S. Cl. 430/270.1

(57) ABSTRACT

A negative resist composition includes a polymer having any one of dicarboxylate monoester compounds represented by the following general formulae (1) and (2) as a monomer component: 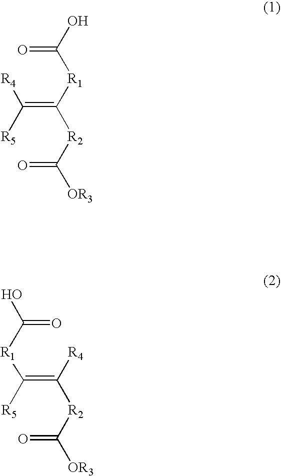
wherein, R₁ and R₂ represent alkyl chains having 0 to 8 carbon atoms, R₃ represents a substituent having at least two or more alicyclic structures, and R₄ and R₅ represent hydrogen atoms or alkyl groups having 1 to 8 carbon atoms. A method for forming a resist pattern uses the above negative resist composition. By containing the polymer, a resistance to dry etching and a resistance to electron beam from a scanning electron microscope (SEM) are enhanced as well as a solubility in an alkali developing solution is maintained.

### TECHNICAL FIELD

The present invention relates to a negative type resist composition suitably used for mainly a photoresist film material and a method of forming a resist pattern, and more particularly relates to a negative type resist composition whose resistances to dry etching and scanning electron beam of a scanning electron microscope are enhanced and a solubility in an alkali developing solution is maintained, and a method for forming a resist pattern.

### BACKGROUND ART

Conventionally, chemical amplification type negative resists have been known as negative type resists. This chemical amplification type negative resists include a combination of an acid generating agent, an alkali-soluble resin such as novolak resin and polyhydroxystyrene, and an amino resin such as melamine resin and urea resin as a basic component for making an exposed area alkali-insoluble (e.g., Patent Document 1 [Japanese Patent Publication Hei 8-3635 B]). In such a negative resist, a negative resist pattern is formed by crosslinking the alkali-soluble resin with the amino resin in the exposed area by an action of an acid generated in the exposed area of a resist film by light irradiation, thereby changing the exposed area to being alkali-insoluble, and by washing the resist film with the alkali to dissolve and remove an unexposed area.

Such a chemical amplification negative resist composed of the combination of the acid generator and the alkali-soluble resin and the amino resin may be sufficiently used for a process using i-ray and KrF excimer laser light (wavelength of 248 nm) as a light source. However, the a chemical amplification negative resist have not been always satisfied as resists for lithography (negative resists for ArF) using ArF excimer laser light (wavelength of 193 nm) which is developed to respond to recent high level integration of semiconductors.

Thus, concerning the negative resist for ArF, for example, the negative resist for ArF which uses a copolymer of 5-methylene-bicyclo[2.2.1]-2-heptane and maleic acid, where one carboxyl group in a maleic acid moiety is esterified as a base polymer and mixed with a cross-linking agent composed of aliphatic cyclic polyhydric alcohol and an acid generator has been proposed (e.g., Non-patent Document 1 [J. Photopolym. Sci. tech., 10(4), pp. 579-584 (1997)]). Likewise, the negative resist for ArF which uses a copolymer of acrylate ester having an epoxy group-containing cyclic hydrocarbon group in an ester moiety and acrylate ester having a carboxyl group-containing cyclic hydrocarbon group in an ester moiety as the base polymer and is mixed with the same cross-linking agent and acid generator as above (e.g., Non-patent Document 2 [J. Photopolym. Sci. Tech., 11(3), pp. 507-512 (1998)]), and the negative resist for ArF which uses a copolymer of acrylate ester having a hydroxyl group-containing cyclic hydrocarbon group in the ester moiety and acrylate ester having a carboxyl group-containing cyclic hydrocarbon group in the ester moiety as the base polymer and is mixed with the same cross-linking agent and acid generator as above (e.g., Non-patent Document 3 [SPIE Advances in Resist technology and Processing XIV Vol. 3333, pp. 417-424 (1998)]) have been proposed.

These negative resists for ArF are characterized mainly in that a carboxyl group-containing crosslinked alicyclic hydrocarbon group is introduced into the polymer in order to enhance transparency of the base polymer for the ArF excimer laser light (wavelength of 193 nm) as well as make the base polymer soluble in alkali, and in that the epoxy group or an alcoholic hydroxyl group is introduced into the resin for crosslinking.

However, in the negative resists having such a composition, although a negative pattern is formed as a result of an ester bond or an ether bond between the cross-linking agent and the base polymer produced in the presence of the acid by the ArF excimer laser light, the carboxyl group or the alcoholic hydroxyl group which has not been crosslinked is remained in the exposed area. Thus, there is a drawback that they may swell during development in alkali, thereby causing a round shaped resist pattern.

On the contrary, a negative resist composition capable of being developed in alkali, containing a compound (A) which generates an acid by receiving light irradiation and a resin (B) which becomes insoluble in the alkali by the acid has been proposed (e.g., Patent Document 2 [Japanese Patent Application Laid-Open 2000-206694 A]). This negative resist composition is characterized in that the component (B) is a copolymer (referred to as a “first generation copolymer”) of at least one monomer (a) selected from α-(hydroxyalkyl)acrylic acid and α-(hydroxyalkyl)acrylate alkyl ester with at least one monomer (b) selected from other ethylenic unsaturated carboxylic acid and ethylenic unsaturated carboxylate ester.

### DISCLOSURE OF THE INVENTION

However, there arises the problems that the first generation copolymer lacks a resistance to dry etching and that, when the pattern of the resulting resist is evaluated by a scanning electron microscope (SEM), the pattern can not be accurately evaluated because the electron beam causes pattern shrinkage. In particular, the latter problem where the pattern can not be accurately evaluated will lead that data reliability becomes doubtful and consequently reliability of commercial products becomes doubtful. Therefore, this problem has been major concerns.

The present invention has been made in the light of such a conventional circumstance, and an object of the present invention is to provide a negative resist composition whose resistance to dry etching and resistance to scanning electron beam (referred to as SEM resistance, hereinafter) of a scanning electron microscope (SEM) are enhanced and a solubility in an alkali developing solution is maintained, and a method of forming a resist pattern using the resist composition.

In order to solve the problems, a negative resist composition according to the present invention is characterized in that the negative resist composition comprises:

a polymer having any one of dicarboxylate monoester compounds represented by the following general formulae (1) and (2) as a monomer component: 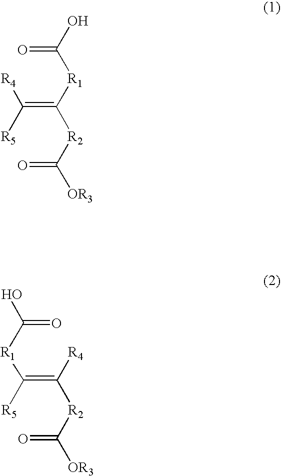
wherein, R₁ and R₂ represent alkyl chains having 0 to 8 carbon atoms, R₃ represents a substituent having at least two or more alicyclic structures, and R₄ and R₅ represent hydrogen atoms or alkyl groups having 1 to 8 carbon atoms; and

an acid generator which generates an acid by receiving light irradiation.

A method of forming a resist pattern according to the present invention is characterized in that the method comprises the steps of:

forming a photoresist film on a substrate using the above-mentioned negative resist composition; and

forming a predetermined resist pattern on the substrate by applying an exposure treatment and a development treatment to the photoresist film.

According to the present invention, a resistance to dry etching and a resistance to the electron beam of the scanning electron microscope (SEM resistance) are enhanced as well as a solubility in an alkali developing solution can be maintained, therefore, preferable resist pattern may be obtained. In addition, good-shaped pattern may be obtained because the resin does not swell. Furthermore, adhesiveness to a substrate is enhanced.

### BEST MODES FOR CARRYING OUT THE INVENTION

The negative resist composition according to the present invention, as mentioned above, is characterized in that the negative resist composition comprises: a polymer having any one of dicarboxylate monoester compounds represented by the above general formulae (1) and (2) as a monomer component; and an acid generator which generates an acid by receiving light irradiation.

In the present invention, the term “having at least two or more alicyclic structures” means that a substituent may have two or more alicyclic structures independently therein and may have in a form of a condensed ring or a spiro ring. Large carbon density of the condensed ring is preferable in terms of the enhanced resistance to etching of the polymer obtained. Such a substituent having two or more alicyclic structures is preferably at least one specifically selected from the group consisting of adamantane, tricyclodecane, tetracyclodecane, isobornyl, norbornene, adamantane alcohol, norbornene lactone, or derivatives thereof. As the dicarboxylate monoester compounds according to the invention, fumarate monoester and itaconate monoester are particularly preferable. Specific examples thereof may include monoadamantyl fumarate, monomethyladamantyl fumarate, monoethyladamantyl fumarate, monoisobornyl fumarate, mononorbornyl fumarate, dicyclopentenyl fumarate, dicyclopentanyl fumarate, monoadamantyl itaconate, monomethyladamantyl itaconate, monoethyladamantyl itaconate, monoisobornyl itaconate, mononorbornyl itaconate, dicyclopentenyl itaconate and dicyclopentanyl itaconate.

The most suitable dicarboxylate monoester compound as a constituting monomer of the base polymer according to the present invention is represented by the general formula (1) or (2) as described above. Examples of the alkyl chains represented by R₁ and R₂ having 0 to 8 carbon atoms in this formula may include —CH₂—, —CH₂CH₂—, —CH(CH₃)CH₂—, —C(CH₃)₂— and —(CH₂)₈—.

The dicarboxylate monoester compound may be produced efficiently by, for example, the following method of producing the dicarboxylate monoester compound according to the present invention.

That is, the dicarboxylate monoester compound represented by the general formulae (1) and (2) may be yielded by reacting dicarboxylic acid represented by the following general formula (4), (5) or (6) and/or an anhydrate thereof with alcohol. In these formulae, R₁ and R₂ represent alkyl groups having 0 to 8 carbon atoms, R₄ and R₅ represent hydrogen atoms or alkyl groups having 1 to 8 carbon atoms.

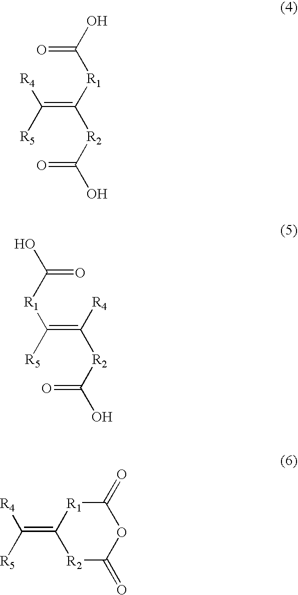

Examples of dicarboxylic acid represented by the above general formula (4), (5) or (6) and/or an anhydrate thereof may include fumaric acid, itaconic acid, itaconic acid anhydrate, mesaconic acid, glutaconic acid and traumatic acid, and itaconic acid anhydrate is the most preferable because its reactivity is high.

Examples of the aforementioned alcohol may include borneol, norborneol, 1-adamantanol, 2-adamantanol, adamantane-1,3-diol, 2-methyl-2-adamantanol, tricyclodecanol and dicyclopentenyl oxyethanol.

An amount of alcohol to be added to the dicarboxylic acid and/or dicarboxylic acid anhydrate is preferably 40 to 300 parts by weight based on 100 parts by weight of the dicarboxylic acid and/or dicarboxylic acid anhydrate.

A reaction condition for an esterification reaction using the dicarboxylic acid and/or dicarboxylic acid anhydrate with alcohol is not particularly limited, but it is preferable to perform under the temperature condition at 30 to 140° C.

Additionally, a solvent and the like may be used appropriately for the reaction.

One example of the polymer according to the present invention may include a structural unit represented by the following general formula (7) or (8). The polymer having this dicarboxylate monoester structural unit is not particularly limited, and in these formulae, R₁ and R₂ represent alkyl groups having 0 to 8 carbon atoms, R₃ is a substituent having at least two or more alicyclic structures, and R₄ and R₅ are hydrogen atoms or alkyl groups having 1 to 8 carbon atoms.

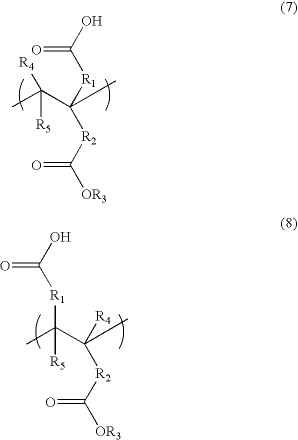

In particular, as the polymer having the aforementioned dicarboxylate monoester structural unit, the polymer where the group represented by R₃ is the substituent having the alicyclic structure having 4 to 30 carbon atoms, and more preferably the substituent having the alicyclic structure having 8 to 20 carbon atoms is useful.

The polymer having the dicarboxylate monoester structural unit according to the present invention is easily produced by polymerizing the dicarboxylate monoester compound represented by the above formulae (1) and (2) alone, or copolymerizing the dicarboxylate monoester compound with the other polymerizable monomer.

Examples of the copolymerizable monomer with the dicarboxylate monoester compound may include (meth)acrylic acid and esters thereof; styrene based compounds such as styrene, α-methylstyrene, 4-hydroxystyrene and 4-tert-butoxystyrene; (meth)acrylonitrile, α-hydroxyalkyl acrylic acid and esters thereof; 5-norbornene-2-carboxylic acid and esters thereof, 5-norbornene-2,3-dicarboxylic acid anhydrate and esters thereof, 5-norbornene-2-methanol, maleic acid anhydrate and esters thereof, and maleimides.

Among them, preferably used is α-hydroxyalkyl acrylic acid represented by the above general formula (3) and esters thereof.

In the above general formula (3), R₆ may include alkyl groups having 1 to 8 carbon atoms or a polycyclic hydrocarbon groups.

Among such substituents, the preferable substituents may include lower alkyl groups such as methyl group, ethyl group, propyl group, isopropyl group, n-butyl group, sec-butyl group, tert-butyl group and amyl group, and crosslinked polycyclic hydrocarbon groups such as bicyclo[2.2.1]heptyl group, bornyl group, adamantyl group, tetracyclo[4.4.0.1^{2.5}.1^{7.10}]dodecyl group and tricyclo[5.2.1.0^{2.6}]decyl group. Those where the alkyl group in the ester moiety is the polycyclic hydrocarbon group are effective for enhancing the resistance to dry etching. In these alkyl groups, particularly the lower alkyl groups such as methyl group, ethyl group, propyl group and butyl group are preferable because those which are inexpensive and easily available may be used as an alcohol component for forming the ester.

In the above general formula (3), R₇ is preferably an alkyl group having 1 to 8 carbon atoms, and more preferably a lower alkyl group such as methyl group, ethyl group, propyl group and butyl group. In particular, methyl group and ethyl group are preferable in terms of easiness of ester formation.

The method of producing the polymer or copolymer having the aforementioned dicarboxylate monoester structural unit is not particularly limited. For example, a polymerization method using a polymerization initiator such as peroxide such as benzoyl peroxide and an azo compound such as 2,2′-azobisisobutylonitrile and 2,2′-azobis(2-methylpropionate) may be employed.

The amount to be used and a type of the copolymer having the dicarboxylate monoester structural unit according to the present invention, namely, a structural unit ratio of the dicarboxylate monoester compound to the copolymer are not particularly limited.

A polymerization degree of the polymer having the dicarboxylate monoester structural unit according to the present invention is set so that a weight-average molecular weight is preferably in the range of 1,500 to 100,000, more preferably 2,000 to 50,000, and still more preferably 2,000 to 30,000. Even in this range, the weight-average molecular weight in the range of 2,000 to 4,000 is particularly preferable because a polymer chain is appropriately short, crosslinking is uniform, occurrence of microbridge caused by pattern swelling at over exposure and in a resolution limit area can be reduced, and the resolution and rectangular property are favorable. The polymers having the dicarboxylate monoester structural unit, whose weight-average molecular weight is 2,000 to 10,000 are useful because they are easily yielded by an ordinary radical polymerization and easily handled. It is preferable that the above polymerization reaction is performed under an atmosphere of inert gas such as nitrogen gas. The molecular weight may be controlled by adjusting a monomer concentration, an initiator concentration and a chain-transfer agent concentration in the polymerization.

The negative resist composition according to the present invention contains at least the aforementioned polymer and the acid generator. The term “acid generator” refers to a compound which generates an acid by irradiation of radiation ray. The acid generator may be used by appropriately selecting from publicly known acid generators used in conventional chemical amplification type negative photoresists. In particular, an onium salt which contains alkyl or halogen substituted alkyl sulfonate ion as an anion is particularly suitable. Examples of cation of this onium salt may preferably include phenyl iodonium and sulfonium which may be substituted with lower alkyl groups such as methyl group, ethyl group, propyl group, n-butyl group and tert-butyl group, or with lower alkoxy groups such as methoxy group and ethoxy group, and dimethyl(4-hydroxynaphthyl)sulfonium.

Meanwhile, as the anion, fluoroalkyl sulfonate ion where a part of or all hydrogen atoms in the alkyl group having 1 to 10 carbon atoms are substituted with fluorine atoms is preferable. In addition, the fluoroalkyl sulfonate ion where all hydrogen atoms in the alkyl group having 1 to 5 carbon atoms are substituted with the fluorine atoms is preferable because the longer the carbon chain is and the smaller a fluorinated ratio (ratio of fluorine atoms in alkyl group) is, the more an intensity as sulfonic acid is lowered.

Examples of such onium salts may include trifluorometanesulfonate or nonafluorobutanesulfonate of diphenyliodonium, trifluorometanesulfonate or nonafluorobutanesulfonate of bis(4-tert-butylphenyl)iodonium, trifluorometanesulfonate or nonafluorobutanesulfonate of triphenylsulfonium, trifluorometanesulfonate or nonafluorobutanesulfonate of tri(4-methylphenyl)sulfonium, trifluorometanesulfonate or nonafluorobutanesulfonate of dimethyl(4-hydroxynaphthyl)sulfonium. In the present invention, the acid generator may be used alone or in combination of two or more.

The negative resist composition of the invention may contain a cross-linking agent as desired for the purposes of further enhancing crosslinking density and enhancing a shape, the resolution and the resistance to dry etching of the resist pattern.

This cross-linking agent is not particularly limited, and may be used by appropriately selecting any one from publicly known cross-linking agents used in the conventional chemical amplification type negative resists. Examples of this cross-linking agent may include aliphatic cyclic hydrocarbon or oxygen-containing derivatives thereof having a hydroxyl group or a hydroxyalkyl group or both, such as 2,3-dihydroxy-5-hydroxymethyl norbornane, 2-hydroxy-5,6-bis(hydroxymethyl)norbornane, cyclohexane dimethanol, 3,4,8(or 9)-trihydroxytricyclodecane, 2-methyl-2-adamantanol, 1,4-dioxane-2,3-diol and 1,3,5-trihydroxycyclohexane, and compounds obtained by reacting formaldehyde or formaldehyde and lower alcohol with an amino group-containing compound such as melamine, acetoguanamine, benzoguanamine, urea, ethylene urea and glycoluril and substituting a hydrogen atom of the amino group with a hydroxymethyl group or a lower alkoxymethyl group, specifically, hexamethoxymethylmelamine, bismethoxymethylurea, bismethoxymethylbismethoxyethyleneurea, tetramethoxymethylglycoluril, and tetrabutoxymethylglycoluril. Particularly preferred is tetrabutoxymethylglycoluril. In the present invention, the cross-linking agent may be used alone or in combination of two or more.

It is preferable that the composition according to the present invention is used in a form of a solution in which the above components are dissolved in a solvent when used. Examples of such a solvent may include ketones such as acetone, methyl ethyl ketone, cyclohexanone, methyl isoamyl ketone and 2-heptane; polyhydric alcohols and derivatives thereof such as ethylene glycol, ethylene glycol monoacetate, diethylene glycol, diethylene glycol monoacetate, propylene glycol, propylene glycol monoacetate, dipropylene glycol or dipropylene glycol monoacetate, or monomethyl ether, monoethyl ether, monopropyl ether, monobutyl ether or monophenyl ether thereof; cyclic ethers such as dioxane; esters such as methyl lactate, ethyl lactate, methyl acetate, ethyl acetate, butyl acetate, methyl pyruvate, ethyl pyruvate, methyl methoxypropionate and ethyl ethoxypropionate; and amide based solvents such as N,N-dimethylformamide, N,N-dimethylacetamide and N-methyl-2-pyrrolidone. These may be used alone or in mixture of two or more. Furthermore, the above various solvents may be used by mixing with water.

In the negative resist composition according to the present invention, miscible additives, e.g., an additive resin, a plasticizer, a stabilizer, a coloring agent and a surfactant commonly used for improving the performance of the resist film may further be added if desired.

The method of using the negative resist composition according to the invention may include the method of forming the resist pattern of the conventional resist technology. To suitably perform the method, first, a solution of the resist composition is applied on a support such as a silicon wafer using a spinner, and dried to form a photosensitive layer. Then, ArF excimer laser light is irradiated to the photosensitive layer through a desired mask using a reduced projection exposure apparatus and the like, and subsequently heated. Next, the photosensitive layer is developed using a developing solution, e.g., an alkali aqueous solution such as an aqueous solution of 0.01 to 10% by weight tetramethylammonium hydroxide. An image in accordance with the mask pattern may be obtained by this formation method.

A substrate to which the negative resist composition according to the invention is applied is not particularly limited, may be any of various substrates, e.g., silicon wafers, silicon wafers with which an organic or inorganic anti-reflection film has been provided and glass substrates, to which the conventional negative resists are applied.

### EXAMPLES

Examples of the present invention will be described below, but these Examples are only exemplifications for suitably describing the invention and do not limit the invention.

### Example 1

As a specific example of the dicarboxylate monoester compound according to the present invention, monoisobornyl itaconate was synthesized as follows.

(i) Reaction of Itaconic Acid Anhydrate with Borneol

200.0 g of itaconic acid anhydrate (1.78 mol), 183.6 g of borneol (1.19 mol), 100.0 g of propylene glycol monomethyl ether acetate and 0.02 g of p-methoxyphenol were placed in a reaction vessel and heated at 90° C. with stirring. It was avoided to polymerize monomers in an asphyxiant condition by performing air-bubbling during the reaction. The reaction was followed up by measuring an acid value using a potentiometric titration apparatus, and the reaction was completed at the time when the acid value was scarcely changed.

(ii) Liquid Separation and Purification

An organic layer was separated from an aqueous layer by adding a separation solvent to the reaction solution obtained above at a ratio of the reaction solution/n-hexane/water=1/2/1 (weight ratio), and the organic layer was washed 9 times with the same amount of purified water. When emulsion was formed during the separation to make the separation difficult, the separation was continued by adding sodium sulfate at a small amount.

An alkali solution was added to the organic solution after being washed with water at a ratio of the organic layer/an NaOH aqueous solution (4.1%)=1.2/1.1 (weight ratio) in order to change monoisobornyl itaconate to a sodium salt and transfer to the aqueous layer. The amount of monoisobornyl itaconate in the organic layer after being washed with water was measured by analysis of gas chromatography, and the amount of sodium hydroxide to be added was made to be 1.1 times number of moles of monoisobornyl itaconate.

Thereafter, in order to remove borneol, n-hexane was added at a ratio of the aqueous layer/n-hexane=3/1 (weight ratio), and the aqueous layer was washed. This manipulation was repeated 6 times.

Subsequently, the sodium salt of monoisobornyl itaconate was put back to monoisobornyl itaconate to transfer to the organic layer by adding an acid to the aqueous layer at a ratio of the aqueous layer/9.6% H₂SO₄ aqueous solution/n-hexane=3/1/1.4 (weight ratio). The amount of H₂SO₄ to be added was made to be 1.1 times the number of moles of NaOH added at a previous stage.

Thereafter, in order to remove a residual salt, the purified water was added at a ratio of the organic layer/water=1.8/1 (weight ratio) to wash the organic layer 3 times with water.

Na₂SO₄ was added to the final organic layer, which then was dried for about 1 to 2 hours, and subsequently, the solvent, n-hexane was removed by distillation off under reduced pressure using an evaporator and air bubbling at about 40° C.

It was identified by ¹H-NMR and ¹³C-NMR that a reactant yielded in this way was the objective monoisobornyl itaconate ester. The yield was total 200 g and 63% throughout the synthesis reaction and purification. The residual borneol measured by the gas chromatography was 6.0%.

### Example 2

Subsequently, an example in which a copolymer having a dicarboxylate monoester structural unit was synthesized using the monoisobornyl itaconate ester yielded in the above Example 1 will be shown.

0.4 g of α-(hydroxymethyl)acrylic acid methyl (90.3 mmol) represented by the following general formula (10), 11.7 g of α-(hydroxymethyl)acrylic acid ethyl (90.3 mmol) represented by the following general formula (11) and 1.4 g of azobisisobutylolactonitrile which is a polymerization initiator were dissolved in 400 mL of THF (tetrahydrofuran). Into the thus obtained solution, 12.0 g of monoisobornyl itaconate (45.1 mmol) represented by the following general formula (9) was dropped in small amounts.

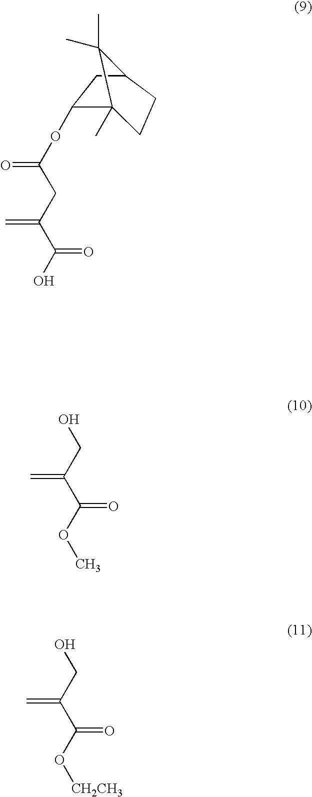

Nitrogen bubbling was performed to this solution for about 10 minutes, the solution was stirred for 4 hours during heating using a water bath at 70° C., and subsequently cooled to room temperature. The solution was exsiccated by drying under reduced pressure at 50° C. for 30 minutes. Further, this was dissolved in THF, filtrated and dried under reduced pressure using a mixed solvent of 800 mL of heptane and 200 mL of isopropyl alcohol, and purified to collect a solid resin.

The weight-average molecular weight in terms of polystyrene was about 5,700 and a degree of dispersion was 1.78 in GPC measurement of the resulting resin.

It was identified by ¹H-NMR and infrared absorption analysis that the yielded resin was the objective copolymer represented by the following general formula (12) of monoisobornyl itaconate, α-(hydroxymethyl)acrylic acid methyl and α-(hydroxymethyl)acrylic acid ethyl. A polymerization ratio (1/m/n) was calculated to be 12/44/44 by measuring monomer consumption rates using gas chromatography.

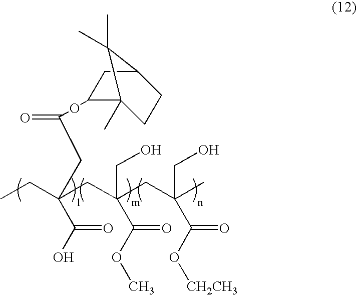

### Example 3

A copolymer represented by the following structural formula (13) was prepared as follows: 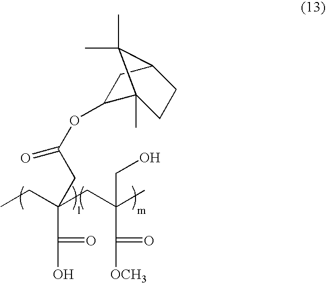
wherein, 1/m was 30/70.

6.0 g of monoisobornyl itaconate (22.6 mmol) yielded in the above Example 1, 6.1 g of α-(hydroxymethyl)acrylic acid methyl (52.6 mmol) and 0.5 g of azobisisobutylolactonitrile which is the polymerization initiator were dissolved into 150 mL of THF (tetrahydrofuran).

Nitrogen bubbling was performed to this solution for about 10 minutes, the solution was stirred for 4 hours with heating using the water bath at 70° C., and subsequently cooled to the room temperature. This solution was exsiccated by drying under reduced pressure at 50° C. for 30 minutes. Further, this was dissolved in THF, filtrated and dried under reduced pressure using a mixed solvent of 820 mL of heptane and 180 mL of isopropyl alcohol, and purified to collect crystals.

The weight-average molecular weight in terms of polystyrene was about 3,000 and the degree of dispersion was 1.78 in the GPC measurement of the resulting resin.

Using the copolymer represented by the above structural formula (13) obtained as above as a base polymer, 0.5 g of this base polymer, 0.005 g of triphenylsulfonyl perfluorobutanesulfonate, 0.05 g of tetrabutoxymethylated glycoluril and 0.0005 g of triethanolamine were dissolved in 10 g of propylene glycol monomethyl ether to obtain a resist composition.

A resist pattern was formed using the resist composition obtained as above. Specifically, first, an organic anti-reflection film with a thickness of 82 nm was formed by applying an organic anti-reflection film composition “AR-19” (trade name, supplied from Shipley Company) on a silicon wafer using a spinner and baking on a hotplate at 215° C. for 60 seconds to dry. A resist film with a thickness of 300 nm was formed by applying the aforementioned resist composition on the anti-reflection film using the spinner and baking on the hotplate at 100° C. for 60 seconds to dry.

Subsequently, pattern light was irradiated (exposure) through a mask pattern using ArF excimer laser (wavelength of 193 nm) by an exposure apparatus NSR-S302 inline (supplied from Nikon Corporation, NA [numerical apertures]/σ=0.6/0.75 annular).

Then, a PEB treatment at 100° C. for 60 seconds was given to the resist film, which was then developed by giving a puddle treatment with an aqueous solution of 2.38% tetraammonium hydroxide for 60 seconds. Thereafter, a post-exposure baking at 100° C. for 60 seconds was performed.

The resist pattern was observed by a scanning electron microscope (SEM), and consequently, the resist pattern having favorable 160 nm line and space (L/S) and having no swelling was obtained and the resistance to etching was also high. At that time, no shrinkage attributed to film thinning of the resist pattern caused by irradiation of the scanning electron beam of the SEM was observed. Furthermore, adhesiveness of the resist pattern to the substrate was sufficient.

### Example 4

A resist pattern was formed by the same way as in Example 3 except that 1/m in the polymer represented by the above structural formula (13) was 40/60 (but the amounts of respective monomers, monoisobornyl itaconate and α-(hydroxymethyl)acrylic acid methyl were 8.2 g (30.8 mmol) and 5.4 g (46.6 mmol), respectively) and a dimension of the resist pattern was 140 nm L/S. The weight-average molecular weight in terms of polystyrene was about 2,700 and a degree of dispersion was 1.63 in GPC measurement of the resulting resin.

As a result, although shrinkage which had practically no problem was observed, the nearly favorable resist pattern was formed. No shrinkage which was problematic occurred by giving the electron beam when observed by SEM.

### Example 5

Using the polymer yielded in the above Example 2 as the base polymer, 0.5 g of this base polymer, 0.005 g of triphenylsulfonyl perfluorobutanesulfonate, 0.05 g of tetrabutoxymethylated glycoluril and 0.0005 g of triethanolamine were dissolved in 10 g of propylene glycol monomethyl ether to obtain a resist composition.

A resist pattern was formed using the resist composition obtained as the above. Specifically, first, an organic anti-reflection film with a thickness of 82 nm was formed by applying an organic anti-reflection film composition “AR-19” (trade name, supplied from Shipley Company) on a silicon wafer using the spinner and baking on the hotplate at 215° C. for 60 seconds to dry. A resist film with a thickness of 300 nm was formed on the anti-reflection film by applying the aforementioned resist composition on the anti-reflection film using the spinner and prebaking on the hotplate at 100° C. for 60 seconds to dry.

Subsequently, pattern light was irradiated (exposure) through the mask pattern using ArF excimer laser (wavelength of 193 nm) by the exposure apparatus NSR-S302 inline (supplied from Nikon Corporation, NA [numerical apertures]/σ=0.6/0.75 annular).

Then, a PEB treatment at 100° C. for 60 seconds was given to the resist film, which was then developed by giving the puddle treatment with the aqueous solution of 2.38% tetraammonium hydroxide for 60 seconds. Thereafter, the post-exposure baking at 100° C. for 60 seconds was performed.

The resist pattern was observed by the scanning electron microscope (SEM), and consequently, the resist pattern having favorable 150 nm line and space (L/S) and having no swelling was obtained and the resistance to etching was also high. At that time, no shrinkage attributed to film thinning of the resist pattern caused by irradiation of the scanning electron beam of the SEM was observed. Furthermore, the adhesiveness of the resist pattern to the substrate was sufficient.

### Example 6

In the above Example 3, a resist pattern was formed by the same way as in the above Example 5 except that the dimension of the resist pattern was 120 nm L/S.

As a result, although shrinkage which had practically no problem was observed, the nearly favorable resist pattern was formed. No shrinkage which was problematic occurred by giving the electron beam when observed by SEM.

### Example 7

Using the polymer having the dicarboxylate monoester structural unit represented by the above general formula (12) yielded in the above Example 2 as the base polymer, 10 g of this base polymer, 0.1 g of triphenylsulfonyl perfluorobutanesulfonate, 1 g of tetrabutoxymethylated glycoluril and 0.01 g of triethanolamine were dissolved in 180 g of propylene glycol monomethyl ether to obtain a resist composition.

A resist pattern (220 pitch, 130 nm line/90 nm space) was formed using the resist composition obtained as the above. Specifically, first, an organic anti-reflection film with a thickness of 82 nm was formed by applying an organic anti-reflection film composition “AR-40” (trade name, supplied from Shipley Company) on the silicon wafer using the spinner and baking on the hotplate at 215° C. for 60 seconds to dry. A resist film with a thickness of 240 nm was formed on the anti-reflection film by applying the aforementioned resist composition on the anti-reflection film using the spinner and prebaking on the hotplate at 130° C. for 60 seconds to dry.

Subsequently, pattern light was irradiated (exposure) through the mask pattern using ArF excimer laser (wavelength of 193 nm) by an exposure apparatus NSR-S306 inline (supplied from Nikon Corporation, NA [numerical apertures]=0.78, σ=2/3 annular). An exposure amount was 25.0 mJ/cm².

Then, the PEB treatment at 130° C. for 60 seconds was given to the resist film, which was then developed by giving the puddle treatment with an aqueous solution of 2.38% tetraammonium hydroxide for 60 seconds. Thereafter, a post-exposure baking at 100° C. for 60 seconds was performed.

The resist pattern was observed by the scanning electron microscope (SEM), and consequently, no swelling of the pattern was observed and the microbridges were reduced. No shrinkage attributed to film thinning of the resist pattern caused by irradiation of the scanning electron beam of the SEM was observed. The resistance to etching was also high. Furthermore, the adhesiveness of the resist pattern to the substrate was sufficient. The solubility of the unexposed area in the developing solution was favorable.

### Example 8

Subsequently, an example in which a polymer having the dicarboxylate monoester structural unit represented by the above general formula (12), whose weight-average molecular weight was about 3,300 was synthesized will be shown.

39.6 g of α-(hydroxymethyl)acrylic acid methyl represented by the above general formula (10), 45.0 g of α-(hydroxymethyl)acrylic acid ethyl represented by the above general formula (11) and 1.4 g of azobisisobutylolactonitrile which is the polymerization initiator were dissolved in 400 mL of THF (tetrahydrofuran). Into the thus obtained solution, 32.9 g of monoisobornyl itaconate represented by the above general formula (9) was dropped in small amounts.

Nitrogen bubbling was performed to this solution obtained in this way for about 10 minutes, the solution was stirred for 4 hours during heating using the water bath at 70° C., and subsequently cooled to the room temperature. The solution was exsiccated by drying under reduced pressure at 50° C. for 30 minutes. Further, this was dissolved in THF, filtrated and dried under reduced pressure using a mixed solvent of 800 mL of heptane and 200 mL of isopropyl alcohol, and purified to collect a solid resin.

The weight-average molecular weight in terms of polystyrene was about 3,300 and the degree of dispersion was 1.90 in the GPC measurement of the resulting resin.

It was identified by ¹H-NMR and infrared absorption analysis that the yielded resin was the objective copolymer represented by the above general formula (11) of monoisobornyl itaconate, α-(hydroxymethyl)acrylic acid methyl and α-(hydroxymethyl)acrylic acid ethyl. A polymerization ratio (1/m/n) was calculated to be 12/44/44 by measuring the monomer consumption rate using gas chromatography.

### Example 9

Using the dicarboxylate monoester polymer (weight-average molecular weight: about 3,300) represented by the above general formula (12) yielded in the above Example 8 as the base polymer, 10 g of this base polymer, 0.1 g of triphenylsulfonyl perfluorobutanesulfonate, 1 g of tetrabutoxymethylated glycoluril and 0.01 g of triethanolamine were dissolved in 180 g of propylene glycol monomethyl ether to obtain a resist composition.

A resist pattern (220 pitch, 130 nm line/90 nm space) was formed using the resist composition obtained as the above. Specifically, first, an organic anti-reflection film with a thickness of 82 nm was formed by applying the organic anti-reflection film composition “AR-40” (trade name, supplied from Shipley Company) on the silicon wafer using the spinner and baking on the hotplate at 215° C. for 60 seconds to dry. A resist film with a thickness of 240 nm was formed on the anti-reflection film by applying the aforementioned resist composition on the anti-reflection film using the spinner and prebaking on the hotplate at 130° C. for 60 seconds to dry.

Subsequently, pattern light was irradiated (exposure) through the mask pattern using ArF excimer laser (wavelength of 193 nm) by the exposure apparatus NSR-S306 inline (supplied from Nikon Corporation, NA [numerical apertures]=0.78, σ=2/3 annular). The exposure amount was 47.0 mJ/cm².

Then, the PEB treatment at 130° C. for 60 seconds was given to the resist film, which was then developed by giving the puddle treatment with the aqueous solution of 2.38% tetraammonium hydroxide for 60 seconds. Thereafter, the post-exposure baking at 100° C. for 60 seconds was performed.

The resist pattern was observed by the scanning electron microscope (SEM), and consequently, no swelling of the pattern was observed and the microbridges were reduced. The resolution and the rectangular property were also excellent, and the basic performance such as exposure margin was also favorable.

### Comparative Example 1

A binary copolymer represented by the following structural formula (14) was prepared as follows: 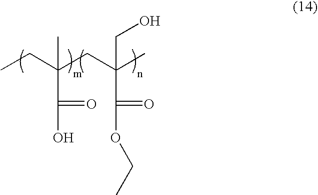
wherein, m/n was 20/80.

2.1 g of methacrylic acid (24.4 mmol), 16.5 g of α-(hydroxymethyl)acrylic acid ethyl (126.9 mmol) and 1.0 g of azobisisobutylolactonitrile which is the polymerization initiator were dissolved in 300 mL of THF (tetrahydrofuran).

Nitrogen bubbling was performed to this solution for about 10 minutes, the solution was stirred for 4 hours with heating using the water bath at 70° C., and subsequently cooled to the room temperature. This solution was exsiccated by drying under reduced pressure at 50° C. for 30 minutes. Further, this was dissolved in THF, filtrated and dried under reduced pressure, using a mixed solvent of 850 mL of heptane and 150 mL of isopropyl alcohol, and purified to collect crystals.

The weight-average molecular weight in terms of polystyrene was about 9,700 and the degree of dispersion was 1.76 in the GPC measurement of the resulting resin.

Using the binary copolymer represented by the structural formula (14) obtained as above as the base polymer, 0.5 g of this base polymer, 0.05 g of triphenylsulfonyl perfluorobutanesulfonate, 0.05 g of tetrabutoxymethylated glycoluril and 0.03 g of 4-phenylpyridine were dissolved in 5.5 g of propylene glycol monomethyl ether to obtain a resist composition.

A resist pattern was formed using the resist composition obtained as above. Specifically, first, an organic anti-reflection film with a thickness of 82 nm was formed by applying the organic anti-reflection film composition “AR-19” (trade name, supplied from Shipley Company) on the silicon wafer using the spinner and baking on the hotplate at 215° C. for 60 seconds to dry.

A resist film with a thickness of 300 nm was formed on the anti-reflection film by applying the aforementioned resist composition on the anti-reflection film using the spinner and prebaking on the hotplate at 100° C. for 60 seconds.

Subsequently, pattern light was irradiated (exposure) through the mask pattern using ArF excimer laser (wavelength of 193 nm) by the exposure apparatus NSR-S302 inline (supplied from Nikon Corporation, NA [numerical apertures]/σ=0.6/0.75 annular).

Then, the PEB treatment at 100° C. for 60 seconds was given to the resist film, which was then developed by giving the puddle treatment with the aqueous solution of 2.38% tetraanmonium hydroxide for 60 seconds. Thereafter, the post-exposure baking at 100° C. for 60 seconds was performed.

The resist pattern was observed by the scanning electron microscope (SEM), and consequently, the line pattern of 160 nm L/S largely swelled and was off from practical use. The SEM resistance could not be identified because a swelling level was too large.

### INDUSTRIAL APPLICABILITY

As described above, the novel negative resist composition according to the present invention may be utilized suitably for the photoresist film material.

### REFERENCES

Patent Document 1: Japanese Patent Publication Hei 8-3635 B
Patent Document 2: Japanese Patent Application Laid-Open 2000-206694 A
Non-patent Document 1: J. Photopolym. Sci. Tech., 10(4), pp. 579-584 (1997)
Non-Patent Document 2: J. Photopolym. Sci. Tech., 11(3), pp. 507-512 (1998)
Non-patent Document 3: SPIE Advances in Resist Technology and Processing XIV, Vol. 3333, pp. 417-424 (1998)

1-5. (canceled)

6. A negative resist composition comprising:
a polymer having any one of dicarboxylate monoester compounds represented by the following general formulae (1) and (2) as a monomer component: 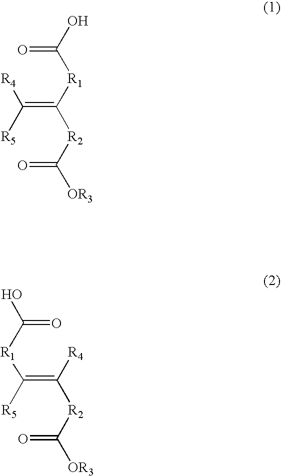
wherein, R₁ and R₂ represent alkyl chains having 0 to 8 carbon atoms, R₃ represents a substituent having at least two or more alicyclic structures, and R₄ and R₅ represent hydrogen atoms or alkyl groups having 1 to 8 carbon atoms; and
an acid generator which generates an acid by receiving light irradiation.

7. The negative resist composition according to claim 6, wherein said substituent having at least two or more alicyclic structures is at least one selected from the group consisting of adamantane, tricyclodecane, tetracyclodecane, isobornyl, norbornene, adamantane alcohol and norbornene lactone.

8. The negative resist composition according to claim 6, wherein said polymer is a copolymer of the dicarboxylate monoester compound and other monomer polymerizable with the dicarboxylate monoester compound.

9. The negative resist composition according to claim 8, wherein said other monomer polymerizable with the dicarboxylate monoester compound is at least one monomer represented by the following general formula (3): 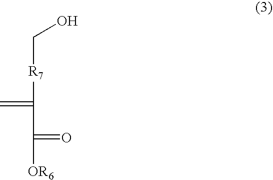
wherein, R₆ represents an alkyl group having 1 to 8 carbon atoms or a polycyclic hydrocarbon group, and R₇ represents an alkyl group having 1 to 8 carbon atoms.

10. A method of forming a resist pattern comprising the steps of:
forming a photoresist film on a substrate using a negative resist composition; and
forming a predetermined resist pattern on the substrate by applying an exposure treatment and a development treatment to the photoresist film,
wherein said negative resist composition comprises:
a polymer having any one of dicarboxylate monoester compounds represented by the following general formulae (1) and (2) as a monomer component: 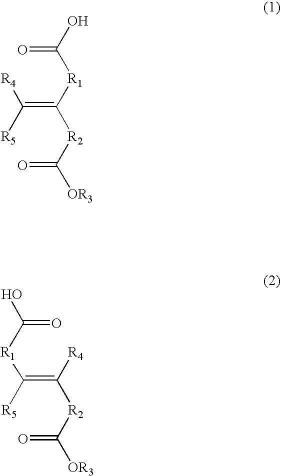
wherein, R₁ and R₂ represent alkyl chains having 0 to 8 carbon atoms, R₃ represents a substituent having at least two or more alicyclic structures, and R₄ and R₅ represent hydrogen atoms or alkyl groups having 1 to 8 carbon atoms; and
an acid generator which generates an acid by receiving light irradiation.
